(19) United States
(12) Patent Application Publication
(10) Pub. No.: US 2017/0162013 A1
(43) Pub. Date: Jun. 8, 2017

(54) OBJECT SECURITY SYSTEM

(71) Applicant: Linctronix Ltd., New Taipei City (TW)

(72) Inventor: MIN-SUNG JAO, TAIPEI CITY (TW)

(21) Appl. No.: 15/370,419

(22) Filed: Dec. 6, 2016

(30) Foreign Application Priority Data
Dec. 8, 2015 (TW) 104141036

(51) Int. Cl. G08B 13/14

(52) U.S. Cl. CPC G08B 13/1427

(57) ABSTRACT

An object security system includes an object detecting unit, a first correspondingly moving unit, and an alerting unit. The object detecting unit is configured on a target object and includes a state detecting module for detecting the present state of the target object and a first wireless transmission module. The first correspondingly moving unit has a second wireless transmission module capable of interacting with the first wireless transmission module to obtain the first distance between the object detecting unit and the first correspondingly moving unit. When the present state detected by the state detecting module is in a specific state and the first distance is over a specific distance, the alerting unit sends an alert signal.

### BACKGROUND OF THE INVENTION

1. Field of the Invention

The present invention relates to an object security system, and more particularly, to an object security system capable of detecting a present state of the target object and a distance between the target object and the protection operator; when the detected present state and the distance data are in abnormal state, the object security system sends an alert signal.

2. Description of the Prior Art

In real life, some specific objects need security due to its particularity, such as valuable products, gems, objects of art or exhibits. In order to prevent theft, we usually set security systems. Besides, in the practical environment, the object that needs security is not limited to product; sometimes, particular persons may also need security, such as important politicians and well-known persons. In the past, such security system usually needs an object to be restricted in a set safety area.

In prior art, the security system is nothing more than the following several ways to achieve the purpose of securing the target object:

1. Put the target object in a specific space or a security space; other people need through specific methods, such as an identity identification card, a password, a fingerprint, a voice print, or pupil scanning, to get identification. After the identification is confirmed, they are allowed to enter into the specific space where the target object is placed;

2. Set a sensor on the target object; when the target object is moved from the original position, then the alert is sent; or

3. Set a locator on the target object to detect the position of the target object; when the position of the target object is away from the specific area or the safety area, then the alert is sent.

The above-mentioned methods are to put the target object at the specific space to process the security protection. However, when the target object is moved, the security system cannot distinguish whether the personnel who moves target object is authorized or not by this method. Therefore other method such as turning off the alarm system is necessary to be adopted on the security protection, so that the authorized personnel can move the target object. Accordingly, the protection method is procedure-complicated and easy to have vulnerabilities when the target object needs to be moved. Additionally, the personnel that is authorized to enter the specific place or safe zone is not necessary to be the personnel that is authorized to move the target object. However, the above-mentioned methods cannot distinguish the difference.

To solved the above-mentioned problem, it is necessary to design a new kind of the object security system that can distinguish whether the target object is moved or protected by the personnel that is authorized to move the target object or not, and warm simultaneously when the target object is moved or over the protection area by the personnel that is not authorized to provide further security protection for the target object.

### SUMMARY OF THE INVENTION

An object of the present invention is to provide an object security system, according to an embodiment of the present invention, the object security system comprises an object detecting unit, one or a plurality of first correspondingly moving units and an alerting unit. The object detecting unit is configured on the target object and comprises a state detecting module for detecting a present state of the target object and a first wireless transmission module. The first correspondingly moving unit comprises a second wireless transmission module, and the second wireless transmission module is capable of interacting with the first wireless transmission module to obtain a first distance between the object detecting unit and the first correspondingly moving unit through detecting the signal strength between each other or other methods. When the present state of the target object detected by the state detecting module is in a predetermined state and the first distance between the object detecting unit and the first correspondingly moving unit is over a predetermined distance, the alerting unit sends an alert signal.

In another embodiment of the present invention, the state detecting module can be an acceleration sensor for detecting the acceleration of the target object (the target object of the present invention can comprise items and personnel), therefore, the state detecting module can detect whether the target object is in the motion state or whether the target object is changed from the stationary state to the motion state, that is to say, the predetermined state can be the motion state or the change of the motion state. When the motion state of the target object is changed or the target object is in the motion state and the first correspondingly moving unit is not within the predetermined distance, it means that the target object is moved by the personnel that is not authorized. Therefore, the alerting unit sends the alert signal.

In another embodiment of the present invention, the state detecting module can be a GPS sensor (comprising global positioning systems or similar satellite positioning systems, and the position and speed of the sensor on the target object are calculated through receiving the satellite information. Therefore, the state detecting module can detect whether the target object is in the motion state or whether the target object is changed from the stationary state to the motion state, that is to say, the predetermined state can be the motion state or the change of the motion state. When the motion state of the target object is changed or the target object is in the motion state and the first correspondingly moving unit is not within the predetermined distance, it means that the target object is moved by the personnel that is not authorized. Therefore, the alerting unit sends the alert signal.

In another embodiment of the present invention, the state detecting module can be an image sensor, and the state detecting module is set on a particular location, so that the image sensor can detect an initial image. Therefore, whether the state detecting module has been moved or not can be confirmed through comparing the image detected by the state detecting module to the initial image. Besides, whether the state detecting module is in the motion state or not can be confirmed through the variable speed of the detected image. That is to say, whether the predetermined state of the target object is in the motion state or the change of the motion state can be confirmed through the image sensor. When the motion state of the target object is changed or the target object is in the motion state, and the first correspondingly moving unit is not within the predetermined distance, it means that the target object is moved by the personnel that is not authorized. Therefore, the alerting unit sends the alert signal.

In another embodiment of the present invention, the state detecting module can be a heartbeat sensor for detecting the heartbeats of the protected target object (this embodiment is for protected person). Therefore, the state detecting module can detect whether the heartbeats of the protected target object are changed sharply/suddenly or the heartbeats of the protected target object cannot be detected due to the removal of the wearing object detection unit. When the heartbeats of the protected target object are changed sharply/suddenly or cannot be detected, and the first correspondingly moving unit is not within the predetermined distance, it means that the target object is moved by the personnel that is not authorized. Therefore, the alerting unit sends the alert signal.

In another embodiment of the present invention, the state detecting module can be a magnetic or corresponding type optical sensor, and the state detecting module can be set on a particular location of the detected target object, and a corresponding magnetic or an optical emitter is set on the external of the state detecting module, so that the state detecting module can detect the magnetism or light generated by the corresponding magnetic or the optical emitter. Therefore, when the magnetism or light detected by the state detecting module is disappeared, the state detecting module can confirm that the target object is in the motion state. When the motion state of the target object is changed or the target object is in the motion state, and the first correspondingly moving unit is not within the predetermined distance, it means that the target object is moved by the personnel that is not authorized. Therefore, the alerting unit sends the alert signal.

In another embodiment of the present invention, the state detecting module can be any kinds of sensors such as temperature, pressure, humidity, gas or other sensors sensing the predetermined states. The state detecting module can be set at the specific temperature, pressure, humidity, gas or other corresponding environment when being used, therefore the specific value corresponding to the environment can be detected. When the value corresponding to the environment detected by the state detecting module is changed, the state detecting module can confirm that the target object is in the state of being removed from the environment or the specific temperature, pressure, humidity, gas or other corresponding state of the environment has been changed. When the corresponding state of the target object is changed and the first correspondingly moving unit is not within the predetermined distance, it means that the target object is moved by the personnel that is not authorized or the state of the environment is being changed. Therefore, the alerting unit sends the alert signal.

The advantages and spirits of the invention may be understood by the following recitations together with the appended drawings.

### BRIEF DESCRIPTION OF THE APPENDED DRAWINGS

Some of the embodiments will be described in detail, with reference to the following figures, wherein like designations denote like members, wherein:

FIG. 1 shows a schematic diagram of the object security system in an embodiment of the present invention.

FIG. 2 shows a schematic diagram of the object security system in another embodiment of the present invention.

FIG. 3 shows a schematic diagram of the object security system in another embodiment of the present invention.

FIG. 4 shows a schematic diagram of the object security system in another embodiment of the present invention.

### DETAILED DESCRIPTION OF THE INVENTION

A detailed description of the hereinafter described embodiments of the disclosed apparatus and method are presented herein by way of exemplification and not limitation with reference to the Figures. Although certain embodiments are shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply as an example of embodiments of the present invention.

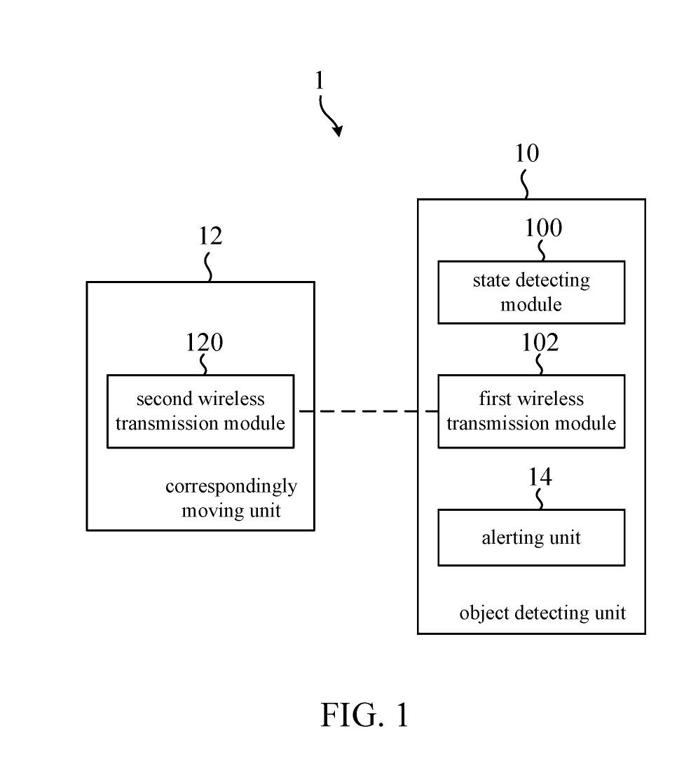

Please refer to FIG. 1. FIG. 1 shows a schematic diagram of the object security system 1 in an embodiment of the present invention. As shown in FIG. 1, the object security system 1 comprises the object detecting unit 10, the first correspondingly moving unit 12 and the alerting unit 14. The object detecting unit 10 can be configured on the target object for detecting the present state of the target object. In the practice application, the target object can be expensive equipment, properties, artwork, exhibits or any object, or the target object can also be a person. Relatively, the first correspondingly moving unit 12 can be set on the specific personnel, for example, setting on the wearing clothes or accessories of the authorized personnel such as guards, security personnel or police. The above-mentioned the object detecting unit 10 and the first correspondingly moving unit 12 can be implanted in the wearable item such as bracelets, necklaces, straps, tags, insoles or small objects that are reusable adhesives such as labels or name tags to provide target personnel or authorized personnel to wear or be set on the carrier carrying the protected target object, for example, made in the shelf, seat or cushion.

The object detecting unit 10 comprises the state detecting module 100, wherein the state detecting module 100 can further comprise one kind or various kinds of acceleration sensors (G-sensor), GPS sensors, image sensors, heartbeat sensors, magnetic sensors, optical sensors, temperature sensors, pressure sensors, humidity sensors, pressure sensors or other sensors that can sense environment change or location movement to detect the current state of the target object. In the practice application, the state of the target object detected by the acceleration sensor is whether the object detecting unit 10 and the target object are moving, remaining still or changing in the speed, such as from the motion state to the stationary state or from the stationary state to the motion state.

In an embodiment of the present invention, the object detecting unit 10 further comprises the first wireless transmission module 102, and accordingly, the first correspondingly moving unit 12 can also comprise the second wireless transmission module 120. When the state detecting module 100 detects that the target object and the object detecting unit 10 are in the predetermined state, for example, the acceleration sensor of the state detecting module 100 detects that the target object is changed from the stationary state to the motion state or is in the motion state continually, then the first wireless transmission module 102 interacts with the second wireless transmission module 120, and the first wireless transmission module 102 detects whether the first distance between the second wireless transmission module 120 is within the predetermined distance.

In the practice application, the first wireless transmission module 102 can send a regional wireless signal, if the second wireless transmission module 120 is within the region that can receive the regional wireless signal, the second wireless transmission module 120 sends back a response signal to the first wireless transmission module 102, and the first wireless transmission module 102 can calculate the first distance between the object detecting unit 10 (and the target object) and the first correspondingly moving unit 12 according to the strength of the response signal.

The alerting unit 14 can be connected within the object detecting unit 10 directly, and receive the first distance between the object detecting unit 10 and the first correspondingly moving unit 12 from the first wireless transmission module 102. In an embodiment of the present invention, the above-mentioned predetermined distance can be set to the distance of one or two human size; in another embodiment of the present invention, the above-mentioned predetermined distance can be set to five meters, ten meters or other suitable distance depending on the number of security personnel to make sure that the protected personnel is within the region of the protection. When the state detecting module 100 of the object detecting unit 10 detects that the target object is in the specific motion state, and the object detecting unit 10 and the first correspondingly moving unit 12 are detected to be out of the predetermined distance, then the alerting unit 14 sends the alert signal. In the practice application, the alerting unit 14 can be achieved by a variety of forms, such as a device that can issue particular sound or flashing light like Electronic buzzers or LED light or a message sending device for generating e-mail, SMS messages, warning messages of phone APP and sending the above mentioned messages to other monitoring devices or monitoring interfaces.

As mentioned above, the object detecting unit 10 is configured on the target object and the first correspondingly moving unit 12 is set on specific personnel. When the object detecting unit 10 detects that the target object is changed in the motion state, such as from the stationary state to the motion state or in the motion state continually, and the first correspondingly moving unit 12 is not within the predetermined distance, the object detecting unit 10 can get that the target object is not moved or delivered by the specific authorized personnel, therefore, the alerting unit 14 sends the alert signal to notify the relevant personnel. It can be seen that the object security system 1 of the present invention can distinguish the authorized personnel that can move the target object, and generate the alarm to the movement of the target object that is not authorized.

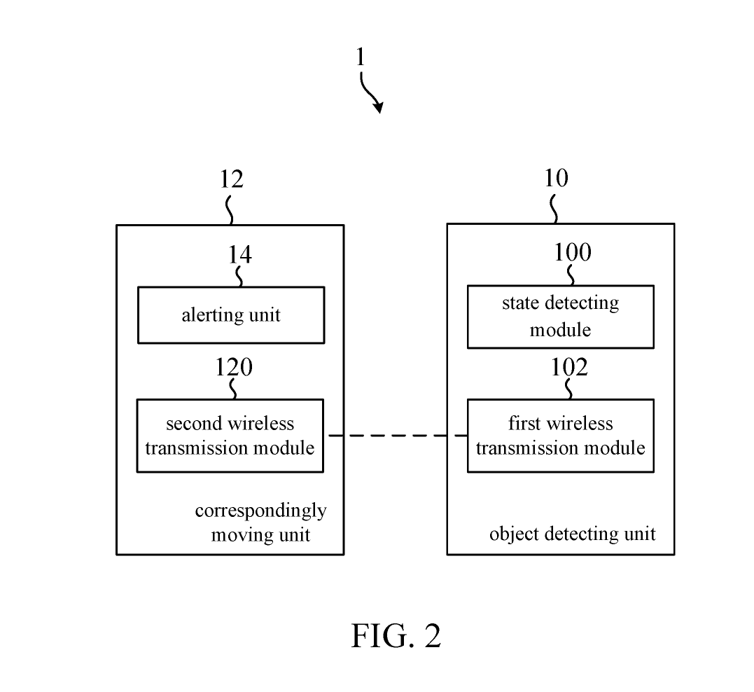

In an embodiment of the present invention, the alerting unit 14 is comprised in the object detecting unit 10 directly; in another embodiment of the present invention, the alerting unit 14 can also be connected to the object detecting unit 10 and set in other part of the target object. In another embodiment of the present invention, the alerting unit 14 can be set in the first correspondingly moving unit 12 or other position. Please refer to FIG. 2. FIG. 2 shows a schematic diagram of the object security system 1 in another embodiment of the present invention. As shown in FIG. 2, the difference between the embodiment and the above-mentioned embodiment is that the alerting unit 14 of the embodiment is comprised in the first correspondingly moving unit 12 directly. When the object detecting unit 10 detects that the target object is in the specific state, such as from the stationary state to the motion state or in the motion state, the first wireless transmission module 102 can transmit a wireless signal to the second wireless transmission module 120 of the first correspondingly moving unit 12, and after the second wireless transmission module 102 receives the wireless signal, the second wireless transmission module 102 determines the first distance between the object detecting unit 10 (that is the target object) and the first correspondingly moving unit 12. The alerting unit 14 comprised in the first correspondingly moving unit 12 can receive the first distance between the object detecting unit 10 and the first correspondingly moving unit 12 from the second wireless transmission module 120 and determine whether the first distance is within a predetermined distance; next, if the first distance is not within the predetermined distance, the alerting unit 14 sends the alert signal to alarm the authorized personnel that wears or sets the first correspondingly moving unit 12.

In another embodiment of the present invention, the alerting unit 14 can set on the object detecting unit 10 and the first correspondingly moving unit 12 respectively. In response to the actual needs, in another better embodiment of the present invention, the alerting unit 14 is set on the place other than the object detecting unit 10 and the first correspondingly moving unit 12; for example, the alerting unit 14 is set at the distal end of the monitoring terminal, when the state detecting module 100 of the object detecting unit 10 detects that the target object is in the predetermined state, the first wireless transmission module 102 and the second wireless transmission module 120 exchange the wireless signal to each other to determine the first distance between the object detecting unit 10 and the first correspondingly moving unit 12. Next, the data and the first distance information are transmitted by the first wireless transmission module 102 or the second wireless transmission module 120 respectively or one of the two transmission modules transmits the determined result to the alerting unit 14; the alerting unit 14 can send the alert signal depending on whether the first distance between the object detecting unit 10 and the first correspondingly moving unit 12 is within the predetermined distance.

In another better embodiment of the present invention, the first wireless transmission module 102 or the second wireless transmission module 120 exchange the wireless signal to each other to determine the first distance between the object detecting unit 10 and the first correspondingly moving unit 12, and the built-in processor of the object detecting unit 10 or the first correspondingly moving unit 12 can determine whether the first distance is within the predetermined distance and transmit the result to the alerting unit 14, so that the alerting unit 14 can send the alert signal directly according to the result. On the other hand, the first wireless transmission module 102 or the second wireless transmission module 120 can also transmit the information such as detection status, signal strength of the interaction between the two, the packet content to the alerting unit 14 directly, and the alerting unit 14 or the computation module connected to the alerting unit 14 calculates whether the first distance is within the predetermined distance, and the alerting unit 14 sends the alert signal according to the result.

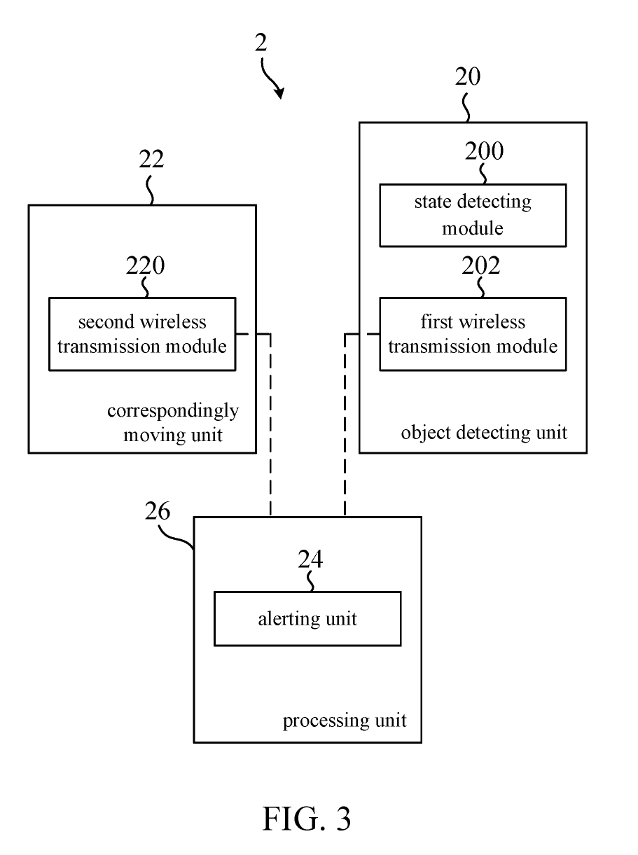

In the above-mentioned embodiments of the present invention, the first wireless transmission module 102 and the second wireless transmission module 120 can obtain the first distance between each other through the interaction of exchanging the wireless signal with each other. In another embodiment of the present invention, the detection of the first distance between the first wireless transmission module 102 and the second wireless transmission module 120 is accomplished via another positioning system. Please refer to FIG. 3. FIG. 3 shows a schematic diagram of the object security system 2 in another embodiment of the present invention. As shown in FIG. 3, the object security system 2 comprises the object detecting unit 20, the first correspondingly moving unit 22, the alerting unit 24 and the processing unit 26. Similarly, the object detecting unit 20 can be configured on the target object, and the first correspondingly moving unit 22 can be configured on the specific person or the authorized personnel.

In an embodiment of the present invention, the object detecting unit 20 comprises the state detecting module 200 and the first wireless transmission module 202, and the first correspondingly moving unit 22 comprises the second wireless transmission module 220, wherein the first wireless transmission module 202 and the second wireless transmission module 220 have the positioning function via satellite positioning, wireless network area positioning, or other methods. In the practice application, the state detecting module 200 detects whether the target object is in the predetermined state or not. When the target object is in the predetermined state, the first wireless transmission module 202 communicates with the processing unit 26 to send the current location of the target object and the object detecting unit 20 to the processing unit 26. Besides, the second wireless transmission module 220 of the first correspondingly moving unit 22 communicates with the processing unit 26 to send the current location of the first correspondingly moving unit 22 to the processing unit 26. The processing unit 26 calculates the first distance between the object detecting unit 20 and the first correspondingly moving unit 22 according to the current location received from the first wireless transmission module 202 and the second wireless transmission module 220, and then the processing unit 26 determines whether the first distance between the object detecting unit 20 and the first correspondingly moving unit 22 is within the predetermined distance. The alerting unit 24 is connected to the processing unit 26, and the processing unit 26 controls whether the alerting unit 24 sends the alert signal or not according to the result of whether the first distance between the object detecting unit 20 and the first correspondingly moving unit 22 is within the predetermined distance. More specifically, when the state detecting module 200 detects that the target object is in the predetermined state, the first wireless transmission module 202 and the second wireless transmission module 220 send the current location of the object detecting unit 20 and the first correspondingly moving unit 22 respectively to the processing unit 26 to calculate the first distance between the object detecting unit 20 and the first correspondingly moving unit 22. Furthermore, if the first distance is over the predetermined distance, the processing unit 26 controls the alerting unit 24 to send the alert signal.

The above-mentioned positioning method via the first wireless transmission module 202, the second wireless transmission module 220 and the processing unit 26 can be any one of the following positioning methods, for example, the processing unit 26 receives the positioning signal with the current location sent from the first wireless transmission module 202 and the second wireless transmission module 220 via a plurality of the wireless signal receivers, and then calculates the actual coordinates of the object detecting unit 20 and the first correspondingly moving unit 22 via different localization algorithms, such as, triangle positioning method, multi-point positioning method or nest positioning method to calculate the relative distance between the two.

In another embodiment of the present invention, since the processing unit 26 can detect the actual coordinates of the object detecting unit 20 and the first correspondingly moving unit 22. Therefore, the object security system 2 can also be connected to other security protection system. For example, the processing unit 26 can be connected to the access control system of the specific area. When the processing unit 26 detects that the first correspondingly moving unit 22 moves from the specific area to the entrance, the processing unit 26 sends the notification message to the access control system of the entrance to operate the action of opening the door, so that the authorized personnel wearing the first correspondingly moving unit 22 can enter the entrance and continues to monitor whether the first distance between the first correspondingly moving unit 22 and the object detecting unit 20 is smaller than the predetermined distance. When the first distance is smaller than the predetermined distance, the system grants the right to operate the following procedure.

In the further embodiment of the present invention, assume that the original position of the target object set with the object detecting unit 20 is within the specific area. When the processing unit 26 detects that the object detecting unit 20 and the first correspondingly moving unit 22 move to the entrance at the same time, the processing unit 26 sends the notification message to the access control system of the entrance, so that the target object and the authorized personnel can go out together; if the processing unit 26 only detects that the object detecting unit 20 moves to the entrance but the first correspondingly moving unit 22 is not within the specific area, then the processing unit 26 can notice the access control system to be closed to prevent the target object from going out.

In another embodiment of the present invention, the object security system of the above-mentioned embodiment can be used in hospital infant rooms, infant centers or post-natal care centers. Infants can wear the clothing, bracelets, footwears or other accessories with the object detecting unit, and the authorized nursing personnel or the families of the infants can wear the clothing or accessory with the first correspondingly moving unit. When the object detecting unit detects that the infant moves (if the authorized nursing personnel or the family of the infant are not within the predetermined distance), the alert signal is sent to prevent the infant from being moved by the unauthorized person. Besides, the access control system of the baby room or the security area can also be connected to the object security system so that the unauthorized person cannot move the baby from the baby room or the similar security area. Please notice that in the practice application, the first correspondingly moving unit worn by the authorized nursing personnel or the families of the infants can has different authorization ranges. For example, the family can move the infant but cannot take the baby out of the security area, while the authorized nursing personnel can take the baby out of the security area.

In another embodiment of the present invention, the pharmacy or the special pharmacy of a medical institution sets the object detecting unit on all kinds of drugs and pharmaceuticals, and sets the first correspondingly moving unit on the pharmacy personnel. When the pharmacy personnel takes the drug, the object detecting unit detects the change of the state and knows that the pharmacy personnel takes the drug, and then triggers the message to the prescription system to record the dispensing procedure of the pharmacy personnel and compare to the prescription of the prescription system. If the prescription is not the same, then the object detecting unit sends the warning to prevent the pharmacy personnel from the dispensing error.

In addition to the above-mentioned practical applications, the object security system of the present invention can also be used to the security of the valuables or the art exhibits to prevent the valuables or the art exhibits from being moved freely by the unauthorized person or being carried out of the specific security area. Besides, the object security system of the present invention can also be used to the security of the important people; more specifically, when the important person wearing the object detecting unit is in the predetermined state, then at least one of the security personnel wearing the first correspondingly moving unit needs to be in the predetermined distance. Otherwise, the alerting unit sends the alert signal to the back-end monitoring system.

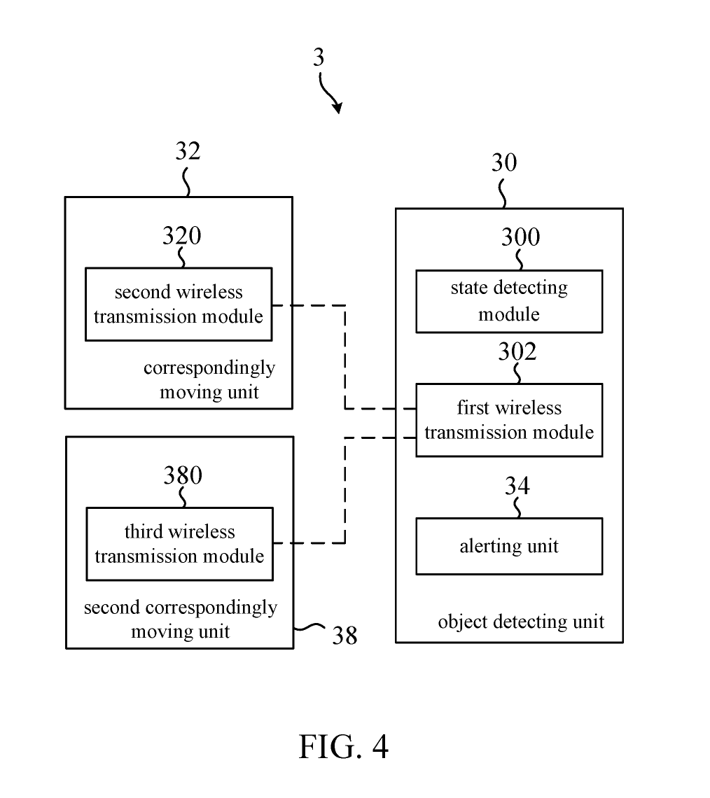

Though the object detecting unit and the first correspondingly moving unit in the above-mentioned embodiments of the present invention are described in one-to-one implementation way, in the practice application, an object detecting unit can also be corresponded to a plurality of the first correspondingly moving units. Please refer to FIG. 4. FIG. 4 shows a schematic diagram of the object security system 3 in another embodiment of the present invention. As shown in FIG. 4, the difference between the embodiment of the present invention and the above-mentioned embodiments of the present invention is that the object security system 3 of the embodiment of the present invention further comprises the second correspondingly moving unit 38, and the second correspondingly moving unit 38 comprises the third wireless communication module 380. The other units of the object security system 3 are substantially the same as the above-mentioned embodiments of the present invention; therefore, it will not be repeated herein again.

In another embodiment of the present invention, when the state detecting module 300 of the object detecting unit 30 detects that the target object is in the predetermined state, the first wireless transmission module 302 can exchange the wireless signal with the second wireless transmission module 320 and the third wireless communication module 380. By doing so, the relative distance between the object detecting unit 30 and the first correspondingly moving unit 32 and the relative distance between the object detecting unit 30 and the second correspondingly moving unit 38 can be obtained.

When the state detecting module 300 of the object detecting unit 30 detects that the target object is in the predetermined state, and if the distance between the object detecting unit 30 and any one of the first correspondingly moving unit 32 and the second correspondingly moving unit 38 is over the predetermined distance, the alerting unit 34 can send the alert signal. In other words, the two authorized personnel represented by the first correspondingly moving unit 32 and the second correspondingly moving unit 38 must approach to the target object at the same time to move or deliver the target object. On the other hand, the system of the present invention can also be set when the state detecting module 300 of the object detecting unit 30 detects that the target object is in the predetermined state, and if the first distance between the object detecting unit 30 and the first correspondingly moving unit 32 and the second distance between the object detecting unit 30 and the second correspondingly moving unit 38 are both over the predetermined distance, so that the alerting unit 34 sends the alert signal. In other words, only one of the two authorized personnel approach to the target object and then the target object can be moved or delivered. In the practice application, the number of the correspondingly moving units is not limited to one or two as the above-mentioned embodiments of the present invention, but can be increased or decreased according to the actual demands. Relatively, a correspondingly moving unit can also be corresponded to a plurality of different object detecting units; in other words, the authorized personnel represented by the correspondingly moving unit can move or deliver a plurality of different target objects.

In the above-mentioned embodiments of the present invention, in addition to the use of the acceleration detector, a GPS sensor (comprising global positioning systems or similar satellite positioning systems) can also be used as the detector in the state detecting module to calculate the position and speed of the sensor on the target object through receiving the satellite information. Therefore, the state detecting module can detect whether the target object is in the motion state or whether the target object is changed from the stationary state to the motion state. That is to say, the predetermined state of the target object can be the motion state or the change of the motion state. When the motion state of the target object is changed or the target object is in the motion state, and the correspondingly moving unit is not within the predetermined distance, it means that the target object is moved by the personnel that is not authorized. Therefore, the alerting unit sends the alert signal.

In the above-mentioned embodiments of the present invention, in addition to the use of the acceleration detector, an image sensor can also be used as the detector in the state detecting module, and the state detecting module is set on a particular location, so that the image sensor can detect an initial image. Therefore, whether the state detecting module has been moved or not can be confirmed through comparing the image detected by the state detecting module to the initial image. Besides, whether the state detecting module is in the motion state or not can be confirmed through the variable speed of the detected image. That is to say, whether the predetermined state of the target object is in the motion state or the change of the motion state can be confirmed through the image sensor. When the motion state of the target object is changed or the target object is in the motion state and the correspondingly moving unit is not within the predetermined distance, it means that the target object is moved by the personnel that is not authorized; therefore, the alerting unit sends the alert signal.

In the above-mentioned embodiments of the present invention, in addition to the use of the acceleration detector, a heartbeat sensor can also be used as the detector in the state detecting module for detecting the heartbeats of the protected target object (this embodiment is for protected person). Therefore, the state detecting module can detect whether the heartbeats of the protected target object are changed sharply/suddenly or the heartbeats of the protected target object cannot be detected due to the removal of the wearing object detection unit. When the heartbeats of the protected target object are changed sharply/suddenly or cannot be detected, and the correspondingly moving unit is not within the predetermined distance, it means that the target object is moved by the personnel that is not authorized. Therefore, the alerting unit sends the alert signal.

In the above-mentioned embodiments of the present invention, in addition to the use of the acceleration detector, a magnetic or corresponding type optical sensor can also be used as the detector in the state detecting module, and the state detecting module can be set on a particular location of the detected target object, and a corresponding magnetic or an optical emitter is set on the external of the state detecting module, so that the state detecting module can detect the magnetism or light generated by the corresponding magnetic or the optical emitter. Therefore, when the magnetism or light detected by the state detecting module is disappeared, the state detecting module can confirm that the target object is in the motion state. When the motion state of the target object is changed or the target object is in the motion state, and the correspondingly moving unit is not within the predetermined distance, it means that the target object is moved by the personnel that is not authorized. Therefore, the alerting unit sends the alert signal.

In the above-mentioned embodiments of the present invention, in addition to the use of the acceleration detector, the detector in the state detecting module can be such as a sensor of temperature/pressure/humidity/gas or other sensor sensing the predetermined state. The state detecting module can be set at the specific temperature, pressure, humidity, gas or other corresponding environment when being used; therefore, the specific value corresponding to the environment can be detected. Accordingly, when the value corresponding to the environment detected by the state detecting module is changed, the state detecting module can confirm that the target object is in the state of being removed from the environment or the specific temperature, pressure, humidity, gas or other corresponding state of the environment has been changed. When the corresponding state of the target object is changed and the correspondingly moving unit is not within the predetermined distance, it means that the target object is moved by the personnel that is not authorized or the state of the environment is being changed. Therefore, the alerting unit sends the alert signal.

With the examples and explanations mentioned above, the features and spirits of the invention are hopefully well described. More importantly, the present invention is not limited to the embodiment described herein. Those skilled in the art will readily observe that numerous modifications and alterations of the device may be made while retaining the teachings of the invention. Accordingly, the above disclosure should be construed as limited only by the metes and bounds of the appended claims.

What is claimed is:

1. An object security system, for processing security to a target object, comprising:
an object detecting unit, configured on the target object, wherein the object detecting unit comprises a state detecting module and a first wireless transmission module, and the state detecting module is used for detecting a present state of the target object;
a first correspondingly moving unit, comprising a second wireless transmission module, wherein the second wireless transmission module is capable of interacting with the first wireless transmission module to obtain a first distance between the object detecting unit and the first correspondingly moving unit;
a second correspondingly moving unit, comprising a third wireless communication module, wherein the third wireless communication module is capable of interacting with the first wireless transmission module to get a second distance between the object detecting unit and the second correspondingly moving unit; and
an alerting unit, for sending an alert signal;
wherein when the present state detected by the state detecting module is in a specific state and at least one of the first distance and the second distance is over a specific distance, the alerting unit sends the alert signal;
wherein when the first correspondingly moving unit and the second correspondingly moving unit approach to the object detecting unit at the same time, the target object can be moved or transported.

2. The object security system of claim 1, wherein the state detecting module is an acceleration sensor, and the specific state is a motion state of the target object.

3. The object security system of claim 1, wherein the state detecting module is an acceleration sensor, and the specific state is the change of the motion state.

4. The object security system of claim 1, 2, or 3, wherein the first wireless transmission module exchanges wireless signal with the second wireless transmission module directly to get the first distance between the object detecting unit and the first correspondingly moving unit.

5. The object security system of claim 4, wherein the alerting unit is configured in the object detecting unit, and the alerting unit receives the first distance from the first wireless transmission module and determines whether the first distance is over the specific distance.

6. The object security system of claim 4, wherein the alerting unit is configured in the first correspondingly moving unit, and the alerting unit receives the first distance from the second wireless transmission module and determines whether the first distance is over the specific distance.

7. The object security system of claim 1, 2, or 3, further comprising a processing unit, wherein the processing unit, the object detecting unit, and the first correspondingly moving unit use wireless transmission to communicate with each other, and the processing unit gets the present state of the target object received by the state detecting module from the first wireless transmission module, and receives the first distance between the object detecting unit and the first correspondingly moving unit from the first wireless transmission module and the second wireless transmission module, and the processing unit further determines whether the present state is in the specific state and whether the first distance is over the specific distance and controls the alerting unit to send the alert signal according to the results.

8. The object security system of claim 1, 2, or 3, further comprising a processing unit, wherein the first wireless transmission module and the second wireless transmission module have the function of position location, and the processing unit, the object detecting unit, and the first correspondingly moving unit use wireless transmission to communicate with each other, and the processing unit gets the present state of the target object received by the state detecting module from the first wireless transmission module, and receives a first position location and a second position location of the first correspondingly moving unit from the first wireless transmission module and the second wireless transmission module directly, and the processing unit calculates the first distance between the target object and the first correspondingly moving unit according to the first position location and the second position location, and the processing unit further determines whether the present state is in the specific state and whether the first distance is over the specific distance and controls the alerting unit to send the alert signal according to the results.

9. The object security system of claim 1, wherein the form of the alert signal sent from the alerting unit contains at least one of the warning messages including a warning sound, a LED flashing, a monitoring interface display signal, an E-mail, a SMS message, and a mobile application.

10. The object security system of claim 1, wherein the first correspondingly moving unit and the second correspondingly moving unit set an authorization effective area, when the present state detected by the state detecting module is in the specific state and at least one of the first correspondingly moving unit and the second correspondingly moving unit is outside of the authorization effective area, the alerting unit sends the alert signal.

11. The object security system of claim 1, wherein the state detecting module is a satellite positioning sensor, and the specific state is a motion state of the target object.

12. The object security system of claim 1, wherein the state detecting module is a heartbeat sensor, and the specific state is a heartbeat numerical range of the target object.

13. The object security system of claim 1, wherein the state detecting module is a temperature sensor, and the specific state is a temperature numerical range.

14. The object security system of claim 1, wherein the number of the object detecting unit is N, and the total number of the first correspondingly moving unit and the second correspondingly moving unit is M, and the corresponding relationship between the object detecting unit and the first correspondingly moving unit and the second correspondingly moving unit is N to M in using, wherein N and M are both natural numbers greater than one.
